(19) United States
(12) Patent Application Publication
(10) Pub. No.: US 2015/0368399 A1
(43) Pub. Date: Dec. 24, 2015

(54) PA-MXDT/ZT COPOLYMERS

(71) Applicant: DSM IP ASSETS B.V., Heerlen (NL)

(72) Inventors: Rudy RULKENS, Echt (NL); Theo Joseph CUYPERS, Echt (NL); Geert Adelina Rudolf VANDEN POEL, Echt (NL); Eric GROLMAN, Echt (NL); Renier Henricus Maria KIERKELS, Echt (NL)

(21) Appl. No.: 14/763,601

(22) PCT Filed: Jan. 30, 2014
(86) PCT No.: PCT/EP2014/051800

§ 371 Date: Jul. 27, 2015

(30) Foreign Application Priority Data
Jan. 30, 2013 (EP) PCT/EP2013/051812

(51) Int. Cl. C08G 69/30; C08G 69/26

(52) U.S. Cl. CPC C08G 69/30; C08G 69/265

(57) ABSTRACT

The invention related to a process for the production of a PA-MXDT/ZT polyamide copolymer comprising the following steps: •i. providing a solid MXDT/ZT salt, wherein MXD is meta-xylylenediamine, T is terephthalic acid, Z is a linear aliphatic diamine having from 2 to 12 carbon atoms and wherein amount of Z is from 5 to 40 mole % with respect to the total amount of MXD and Z units in the copolymer and wherein the MXDT/ZT salt is provided by dosing of liquid diamines MXD and Z to a powder of terephthalic acid; •ii. heating the solid MXDT/ZT salt to a first condensation temperature (Tc1) thereby condensing the salt in solid state to produce a solid polyamide copolymer, wherein Tc1 is below the melting temperature (Tm-salt) of said salt. The invention further relates to a PA-MXDT/ZT polyamide copolymer, wherein MXD is meta-xylylenediamine, T is terephthalic acid, Z is a linear aliphatic diamine having from 2 to 12 carbon atom, Z is from 5 to 40 mole % with respect to the total of MXD and Z units in the copolymer.

The invention relates to a process for the production of a PA-MXDT/ZT polyamide copolymer, wherein MXD is meta-xylylenediamine, T is terephthalic acid, Z is a linear aliphatic diamine having from 2 to 12 carbon atoms.

A process for the production of a transparent polyamide copolymer comprising MXD, a straight chain diamine, terephthalic acid and an aliphatic saturated dicarboxylic acid is known from U.S. Pat. No. 4,018,746. U.S. Pat. No. 4,018,746 describes a process wherein the diamines and the dicarboxylic acids are put in an autoclave. The salts of the diamines and carboxylic acids could be prepared beforehand. The components are heated in a nitrogen stream, while stirring to a temperature in the range of 200° C. to 250° C. Then the stream is let off and the temperature is increased to about 260° C. to 300° C. At this temperature the mixture is stirred for about 30 minutes in a nitrogen stream. The condensation is until the polymer has attained the desired molecular weight.

Replacing adipic acid by the cheaper terephthalic acid and keeping the amorphous transparent character of the polyamide is desired; however the process of U.S. Pat. No. 4,018,746 cannot be used for the production of MXDT/ZT because of the following reasons.
1) A mixture of MXD, Z and T in a composition, wherein the amount of Z is from 5 to 40 mole % with respect to the total amount of MXD and Z units, does not melt and becomes a solid block of sintered powder.
2) Heating 1,4-diaminobutane and/or 1,5-diaminopentane in the presence of an acid at high temperatures cause five- and six-membered monofunctional cycles due to side reactions. They are reactive with RCO₂H and act as chain stoppers, which can limit the molecular weight of the resulting polyamides. Heating longer chain linear aliphatic diamines in the presence of an acid at high temperatures cause multifunctional amines due to side reactions. They are reactive with RCO₂H and act as branching agent, which may cause gelation.
3) When the batch process described in U.S. Pat. No. 4,018,746 is used at large scale, the resulting liquid polyamide at any stage of the process has to be granulated. This implies that the resulting variation in residence time leads to an undesired variation in molecular weight of the polyamide and therefore to an inhomogeneous product. Attempts to produce PA-MXDT/ZT via other known polymerization routes for amorphous polyamides failed as well.

An object of the present invention is to provide a process for the production of PA-MXDT/ZT copolymers that does not suffer from the above-mentioned disadvantages.

According to the invention, this object is reached by the features of claim 1. As a result of the process of claim 1 a PA-MXDT/ZT copolymer, wherein Z is from 5 to 40 mole % with respect to the total of MXD and Z units in the copolymer could be made with a viscosity number measured in H2SO4 of more than 50 ml/g could be produced.

With the expression “from x to y” wherein x and y are numerical values, as for example in “from 2 to 12 carbon atoms” and “from 0 to 40 mole %” is herein meant that the values x and y are included. Thus “from x to y” shall be read as “from x up to and including y”.

A concentration of Z lower than 5 mole % and above 40 mole % with respect to the total molar amount of MXD and Z units in the copolymer, results in a semi-crystalline copolymer which is no longer amorphous.

A Direct Solid State Polymerisation (DSSP) process, i.e. a process in which polyamide salts are polymerized below the melting temperature of the salt, and wherein the salt, the polymer formed and the intermediate reaction mixture remains a solid, is known per se for polyamides, but exclusively for semi-crystalline polyamides. Applying this process for an amorphous semi-aromatic polyamide is not possible due to the absence of reaction below the glass transition temperature (Tg) and above the Tg the material is a liquid or becomes sticky creating sintering of the material.

Surprisingly this DSSP process could be applied for the first time for the production of an amorphous PA-MXDT/ZT copolymer wherein Z is from 5 to 40 mole % with respect to the total of MXD and Z units in the copolymer. The invention therefore also relates to the PA-MXDT/ZT polyamide copolymer, wherein MXD is meta-xylylenediamine, T is terephthalic acid, Z is a linear aliphatic diamine comprising from 2 to 12 carbon atoms, Z is present in an amount ranging from 5 to 40 mole % with respect to the total of MXD and Z units in the copolymer. Preferably Z is 1,4-diaminobutane, 1,5-diaminopentane, hexamethylenediamine, or a mixture (or combination) thereof. Accordingly, if Z represents more than one diamine, the copolymer which is the object of the present invention can be designated as MXDT/Z¹T/Z²T or MXDT/Z¹T/Z²T/Z³T. Preferably, the mixture of diamines is a mixture of diamines selected from the group consisting of 1,4-diaminobutane, 1,5-diaminopentane and hexamethylenediamine.

The process of the invention comprises at least two, optionally three steps.

In a first step (i), a solid MXDT/ZT salt is provided, wherein MXD is meta-xylylenediamine, T is terephthalic acid, Z is a linear aliphatic diamine having from 2 to 12 carbon atoms and wherein Z is from 5 to 40 mole % with respect to the total of MXD and Z units in the copolymer i. and wherein the MXDT/ZT salt is provided by dosing of liquid diamines MXD and Z to a powder of terephthalic acid. In the context of the present invention the mole % is measured by ¹H-NMR.

Providing a solid MXDT/ZT salt can be done by any known process in the art for the preparation of polyamide salts, e.g. a process wherein the MXDT/ZT salt is prepared from diamines MXD and Z and terephthalic acid in an aqueous solution.

Preferably the solid MXDT/ZT salt is provided by a new process wherein the MXDT/ZT salt is prepared by dosing of liquid diamines MXD and Z to an agitated powder of terephthalic acid. An advantage of this process is that the isolation of the resulting salt from the solvent or dispersant are omitted, thereby omitting costs of solvent handling and recycling, and saving on energy costs. The salt obtained in step (i) is already a powder, thus there is no need for crushing and grinding the salt as in the case of salt preparation from solution. The process can be carried out under very mild conditions. There is no need to work under high pressure, or in an atmosphere of superheated steam, or in a complex controlled diamine atmosphere. The process can be performed with a nitrogen gas purge, resulting in faster removal of water resulting from the neutralisation reaction, thereby reducing the risk of caking of the reaction mixture. Preferably, salts prepared according to this method are made from a mix of MXD and diamine Z, wherein Z is a linear aliphatic diamine comprising from 2 to 6 carbon atoms, since this leads to a more favourable reaction between the diamine mix and terephthalic acid to form the MXDT/ZT salt.

In a second step (ii) the solid MXDT/ZT salt is heated to a first condensation temperature (Tc1) thereby condensing the salt in solid state to produce a solid polyamide copolymer, wherein Tc1 is below the melting temperature of said salt (Tm-salt). This first condensation step is considered to be complete if all salt, or nearly so, is converted into polyamide. In case of complete conversion, no residual melting peak from the salt is observable anymore. If so necessary this can be verified with DSC measurements, applying the DSC method and conditions as described further below.

This second step (ii) is herein also referred to as first condensation step. The process suitably comprises one or more further steps.

A preferred third step (iii) of the process of the invention comprises condensing the solid polyamide copolymer from step (ii) at a second condensation temperature (Tc2) below the melting temperature of the polyamide copolymer (Tm1) to produce a polyamide copolymer of a higher degree of polymerization. This third step (iii) is herein also referred to as second condensation step.

The condensation steps (ii) and (iii) may be carried out in any manner suitable for conventional DSSP processes, for example, in a static bed reactor or in an agitated bed reactor. The use of an agitated bed reactor, such as a rotating vessel or a mechanically stirred reactor, wherein the solid MXDT/ZT salt and solid copolymer are agitated thereby creating and maintaining a flowable powder, contribute to the result that the polymer granulate material obtained by the process contributes to the formation of a non-sticky powder material. For the second condensation step (iii) a static bed might be an economically better alternative.

During the condensation steps (ii) and (iii), suitably an inert gas purge is applied to remove any water initially present in the MXDT/ZT salt, and more importantly to remove water produced by the condensation reaction. Alternatively, partial water vapour pressure is reduced by applying a vacuum, or a combination of an inert gas purge and a reduced pressure.

The process can be carried out, for example, as follows. The solid MXDT/ZT salt is prepared in, or alternatively charged to a reactor and heated to a set temperature in the range of 100-200° C., suitably around 130° C., to allow any water in the salt to being removed by evaporation and being carried away via the purge gas, meanwhile keeping the temperature of the reactor wall and internals therein at the same temperature or above to avoid significant condensation on the surfaces. The solid MXDT/ZT salt is suitable staged at that set-temperature for as long as is necessary to remove the water in the salt. This may be checked, for example by means of a water trap. Once the water removal is complete, or nearly so, the solid MXDT/ZT salt is heated to a set point equal to Tc1. The first condensation step may be tracked by the water condensate formation rate, which starts slowly and then increases as the temperature rises. The prepolymerization typically runs until the condensate collection rate drops significantly. The completeness of the conversion of the salt can also be checked with DSC by the absence of residual melting enthalpy reflecting the melt peak of the salt. For the second condensation step (iii) the solid prepolymer formed may either be kept at the same temperature, i.e. Tc2 being equal to Tc1, or may be heated to a set point equal to Tc2 and being higher than Tc1, but below the melting temperature of the polyamide copolymer produced in step (ii). The polyamide is kept at that temperature until the desired degree of polymerization is obtained. Once the polymerization is complete, the polymer is cooled and discharged from the reactor.

Rather than applying discrete sub-steps, the process may also be carried out by applying a temperature gradient going gradually to Tc1 and from Tc1 to Tc2. The heating may be done by applying a temperature ramp. The heating and cooling may be accomplished by heating the inert gas used for the purge, or by heating the reactor walls or internals therein, or any combination thereof.

Preferably the step (i), wherein the solid MXDT/ZT salt is provided, is a process wherein the MXDT/ZT salt is prepared by dosing of liquid diamines MXD and Z to an agitated powder of terephthalic acid. In this process, the salt-preparation is typically carried out in absence of a liquid reaction medium, any solvent or dispensing agent, as is inherent with the conditions of the agitated powder, and in absence of cryogenic cooling agent, as is inherent with the conditions of the dosing temperature being above the melting temperature of the diamine. This does not exclude that during the process liquid components may be added or formed. First of all the diamines are added as a liquid for the salt preparation. Liquid diamine may also be added later, for example during the step (ii) or step (iii). Furthermore, water will be formed during the condensation steps (ii) and (iii) upon reaction of amines and carboxylic acid groups, which water can evaporate and condense.

During the salt-preparation, also some water may be present in the starting materials or being formed during the dosing step. Small amounts of water are not a problem as long as it is possible to maintain a loose and flowable powder. The water can be removed later on during the heating in the first DSSP step.

The solid MXDT/ZT salt as provided in step (i) and used in step (ii) may comprise water, for example about 5 wt. %, while still remaining a flowable solid powder material. Preferably, the MXDT/ZT salt comprises at most 2.5 wt. % of water, more preferably at most 1 wt. % or even better at most 0.5 wt. % water, wherein the wt. % (weight percentage) is relative to the total weight of the salt including the water. In the DSSP process water has to be removed anyway, as water will be formed in the polycondensation reaction.

In the salt-preparation step, the diamines are dosed as a liquid at a dosing temperature above the melting temperature of the diamine mixture and below the melting temperature of the resulting salt and any intermediate products thereof.

For the salt preparation, the dosing temperature is preferably at least 40° C., more preferably at least 60° C. below the melting temperature of the salt (Tm-salt). Using a dosing temperature further below Tm-salt reduces the occurrence of premature condensation reaction of the salt of the diamine and dicarboxylic acid.

Using a lower dosing temperature reduces the problem of freed gaseous water being condensed in cold spots and scaling of powder on such spots.

The diamine is dosed to the agitated powder to form a powder reaction mixture meanwhile retaining an agitated powder. Thus, the diamine is preferably not added and mixed at once with the dicarboxylic acid in the agitated powder, as this could be incompatible with retaining an agitated powder, and could also lead to lumping of wetted parts and incomplete neutralization of non-wetted parts. This would severely complicate and even inhibit the proper mixing of the reacting components. The dosing rate is suitably limited to prevent local accumulation of liquid diamine, thereby preventing excessive wetting, local overheating and premature reaction with release of water resulting in excessive sticking and complicating moving of the bed.

The diamine is also suitably dosed with an average dosing rate between 0.05 mole % of diamine per minute (mppm) (corresponding with an overall dosing time of 33.3 hours) and 5 mole % (20 minutes) of diamine per minute (mppm), preferably between 0.1 mppm (16.7 hours) and 4 mppm (25 min), for example between 0.2 mppm (8.35 hours) and 2 mppm (50 min), or between 0.25 mppm (6.7 hours) and 1 mppm (100 minutes), wherein the mole % of diamine is relative to the molar amount of dicarboxylic acid. The times between brackets indicate the corresponding dosing time.

Long dosing times, respectively low dosing rates may be used, without a significant effect on the salt preparation itself, and will allow more time for the diamines to react with the dicarboxylic acid without creating softening or melting of the acid or solid MXDT/ZT salt, but might make the process less economical. Short dosing times, respectively higher dosing rates may be used, where applicable, however, more energy is needed for good mechanical agitation of the dicarboxylic acid and the reaction mixture to achieve effective dispersion of the diamines in the reaction mixture and for removal of heat resulting from the neutralization reaction between the diamines and terephthalic acid, in order to prevent serious sticking and caking of the reaction mixture. The preferred dosing rate will depend on the manner that the motion in the agitated powder is accomplished, the flow properties of the powder, the way the liquid diamines are dispersed, the reaction components, reaction rate and the reaction conditions applied during dry-mixing. The fastest dosing rate in each individual case can be determined by routine experiments with varying dosing rates.

The MXDT/ZT salt does not necessarily have to be an equimolar salt. The MXDT/ZT salt may still contain some unreacted dicarboxylic acid, for example, if less than an equivalent amount of diamine was used. The salt may also contain some unreacted diamine, for example, if more than an equivalent amount of diamine was used. It has been observed that the MXDT/ZT salt may contain some excess diamine and still show the characteristics of a dry solid powder.

It has further been observed that in case of excess of diamines, the molar balance is at least in part corrected during the first condensation step (ii), by evaporation of diamines, whereas in case of excess of dicarboxylic acid it is possible to correct the molar balance during the second condensation step, step (iii) of the process, by addition of diamines during that step. Therefore, the solid MXDT/ZT salt used in the processes according to the invention suitably has a diamine/dicarboxylic acid molar ratio in the range of 1.10-0.90, preferably 1.05-0.95, and more preferably 1.02-0.98.

The salt preparation step (i) can be carried out in different ways and different types of reactors. Suitably, the diamines and the terephthalic acid are contacted by spraying or dripping the diamines onto the agitated terephthalic acid powder. In a batch wise operation, suitably, the diamines and the terephthalic acid are contacted by spraying or dripping the diamine onto the agitated terephthalic acid powder consequently spraying the diamines onto the agitated mix of formed salt and terephthalic acid powder after addition of the diamines has started. Suitable reactors, in which the diamines and the terephthalic acid can be contacted and mixed, are, for example, tumble mixers, ploughshare mixers, conical mixers, planetary screw mixers and fluidized bed reactors. The said mixers are all low shear mixers. Further information on these and other low shear mixer apparatus can be found in the book “Handbook of Industrial Mixing—Science and Practice” edited by: Paul, Edward L.; Atiemo-Obeng, Victor A.; Kresta, Suzanne M. (Publisher: John Wiley & Sons; 2004;; ISBN: 978-0-471-26919-9; Electronic ISBN: 978-1-60119-414-5), more particularly in Chapter 15, Part 15.4 and 15.11. For removal of neutralization heat, produced upon reaction of the diamines and the terephthalic acid to form the MXDT/ZT salt, a heat exchanger can be used.

The fact that the salt preparation step in the process according to the invention can be carried out without applying a high shear and still provide a high degree of conversion is highly surprising. In fact, the creation of an agitated powder can be accomplished with low shear agitation avoiding attrition of the terephthalic acid powder. In fact the attrition can be so low, or even absent at all, that the particle size distribution is hardly affected, apart from the fact that the size of the terephthalic acid powder particles might be even increased during the reaction with the diamine. The advantage of such low shear agitation without attrition of the terephthalic acid powder, is that amount of fines produced during the process is low, and that problems of fouling, dusting, sagging upon storage, and reduced flowability due to clogging of fines is reduced.

In a preferred embodiment of the process according to the invention, the terephthalic acid powder used therein comprises a low amount of particles with small particle size. Also preferred is a terephthalic acid powder having a narrow particle size distribution. The advantage thereof is that also the resulting MXDT/ZT salt so produced also has less small particles, respectively a relative narrow particle size distribution, and optionally even better flow properties. Suitably, the use of terephthalic acid powder with low amount of small particles and/or narrow particle size distribution is combined with low shear agitation.

The salt preparation step (i), as well as the condensation steps (ii) and (iii) in the process according to the invention are suitably carried out in an inert gas atmosphere. For the inert gas atmosphere, suitable gases as generally known as generally known in the art for the polymerization of polyamides can be used. Such inert gas is typically oxygen-free or essentially so, and free of other oxidative reactive gasses such as O3, HNO3, HClO4 etc. Suitably, nitrogen gas is used as the inert gas. The salt preparation as well as the polymerization steps are suitably carried out at atmospheric pressure, or at a slight overpressure, for example in the range between 1 and 5 bar, for example at about 1.5 bar, or 2 or 3 bar. Using an overpressure has the advantage that diamine losses during salt preparation are reduced, if occurring at all.

Another advantage of the process of the invention is that less side reactions and degradation occur with respect to polymers made by the process described in U.S. Pat. No. 4,018,746. As a result, PA-MXDT/ZT copolymers according to the invention could be made without sintering with a molecular weight expressed as a viscosity number measured in H2SO4 of at least 50 ml/g. Another advantage of the process of the invention over the process described in U.S. Pat. No. 4,018,746 is that the variation in the resulting molecular weight of the PA-MXDT/ZT copolymer is hardly bigger than the variation for any condensation polymerisation, as there is no or hardly any spreading in the residence time.

The PA-MXDT/ZT copolymers are new in the state of the art, as well as the surprising fact that the DSSP process could be used for the production of these transparent amorphous copolymers. Even more surprising was the fact that these copolymers have a melting point in the first DSC heating curve with a melting enthalpy (ΔHm1) of at least at least 25 J/g, preferably at least 40 J/g, most preferably at least 50 J/g. A higher melting enthalpy leads to a lower risk of reactor fouling or powder agglomeration during the polymerization. Herein ΔHm1 is calculated from the melting peak in the first heating cycle. Further, the copolymers according to the present invention, the have a viscosity number (VN) measured in 96% H2SO4 (0.005 g/ml) at 25° C. determined by the method ISO 307, fourth edition of at least 50 ml/g.

In a second heating curve of the DSC, the copolymers show a low melting enthalpy, typically being lower than 25 J/g, or even below 20 J/g. The advantage of a lower melting enthalpy in the second heating is that the materials are more transparent in injection moulding or extrusion applications. By melt-processing, such as injection moulding or melt extrusion, the PA-MXDT/ZT polyamide copolymer is obtained as an (nearly) amorphous copolymer, When this copolyamide is processed with a cooling rate higher than 150° C./min the copolymer becomes fully amorphous and even more transparent as is observed by DSC-experiments in which simulated cooling from 350° C. to room temperature did not show a crystallization peak.

In this application an amorphous copolymer is understood to be polyamides which, in the dynamic differential scanning calorimetry (DSC) according to ISO 1357-1/3, 2009, at a heating rate of 20° C./min, have a melting enthalpy ΔHm2 of at most 25 J/g.

With the term melting temperature (Tm) is herein understood the temperature, measured by the DSC method according to ISO-11357-1/3, 2009, in an N2 atmosphere with a heating and cooling rate of 20° C./min. Herein Tm1, Tm2 is determined from the peak value of the highest melting peak in the first heating cycle, respectively second heating cycle after heating to 350° C. and direct cooling.

With the term melting enthalpy, is herein understood the enthalpy (ΔHm), measured by the DSC method according to 1SO-11357-1/3, 2009, in an N2 atmosphere with a heating and cooling rate of 20° C./min. Herein ΔHm1, ΔHm2 is determined in the first heating cycle, respectively in the second heating cycle after heating to 350° C. and direct cooling.

The invention is further related to a moulding composition comprising the polyamide of the invention. Moulding compositions may comprise fillers like fibrous reinforcing materials, impact modifiers, like elastomers and other additives or processing aids.

Preferred fibrous reinforcing materials are carbon fibers, potassium titanate whiskers, aramid fibers, and particularly preferably glass fibers. If glass fibers are used, these may have been equipped with a coupling agent and with a size to improve compatibility with the thermoplastic polyamide. Suitable particulate fillers are amorphous silica, magnesium carbonate (chalk), kaolin (in particular calcined kaolin), powdered quartz, mica, talc, feldspar, and in particular calcium-silicates, such as wollastonite.

Preferred elastomers are those known as ethylenepropylene (EPM) and ethylene-propylene-diene (EPDM) rubbers. EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Examples of conventional additives are stabilizers and oxidation retarders, agents to counteract thermal decomposition and decomposition via ultraviolet light, lubricants and mold-release agents, dyes, pigments, and plasticizers.

### Raw Materials

Terephthalic acid: powder, industrial grade, melting temperature above 400° C.
Adipic acid: powder, industrial grade
Isophthalic acid: powder, industrial grade
1,4-Diaminobutane: industrial grade; max 1 wt. % water, impurities in ppm range; melting temperature 27.5° C.
Hexamethylene diamine: industrial grade max 1 wt. % water, impurities in ppm range; melting temperature 41° C.
Meta-Xylylene diamine: industrial grade; max 1 wt. % water, impurities in ppm range; melting temperature 14° C.

### Analytical Methods

### Viscosity Number (VN)

The viscosity number (VN) was measured according to ISO 307, fourth edition. For the measurement a pre-dried polymer sample was used, the drying of which was performed under high vacuum (i.e. less than 50 mbar) at 80° C. during 24 hrs. Determination of the viscosity number was done at a concentration of 0.5 gram of polymer in 100 ml of sulphuric acid 96.00±0.15% m/m at 25.00±0.05° C. The flow time of the solution (t) and the solvent (to) were measured using a DIN-Ubbelohde from Schott (ref. no. 53020) at 25° C. The VN is defined as

$$VN = \frac{( \frac{t}{{t}_{0}} - 1 )}{c} = ( \frac{t}{{t}_{0}} - 1 ) * 200$$

wherein:

VN=viscosity number, in ml/g

t=average flow time of the sample solution, in seconds

t₀=average flow time of the solvent, in seconds

c=concentration, in g/ml(=0.005)

Determination of Melting Temperature (Tm) of both the Salt as Well as the Polymer, and Melting Enthalpy (ΔHm) by DSC Method

Melting temperature (Tm) and corresponding melting enthalpy (ΔHm) in the first and second heating of the polymer and the melting temperature of the salt (Tm-salt) are determined by conventional differential scanning calorimetry (DSC) applying the method according to ISO 11357-1/3 (2009). Tm-salt is determined in the first heating. For the measurements a standard heat flux Mettler-Toledo DSC 823 was used and the following conditions applied. Samples of 3 to 10 mg mass were weighed with a precision balance and encapsulated in (crimped) 40 μl aluminium crucibles of known mass. The aluminium crucible was sealed with a perforated aluminium crucible lid. The perforation was mechanically performed and consisted of a hole width of 50 μm. An identical empty crucible was used as a reference. Nitrogen was purged at a rate of 50 ml/min. Heating-cooling-heating cycles with scan rates of 20° C./min, in the range of 0 to 350° C. and immediately cooling after reaching 350° C. were applied.

### EXAMPLES

### S1. Preparation: MXDT/4T Salt

223.35 g (1.344 mole) of solid terephthalic acid powder was charged into a 2 litre baffled flask. The flask was attached to a rotary evaporator equipped with a heated diamine dosing vessel, inertized by purging with 5 gram per hour nitrogen gas for 1 hour. The content in the flask was mixed by rotation of the flask at 60 rpm and kept under nitrogen atmosphere (5 gram per hour). The rotating flask was partially submerged in an oil bath maintained at 65° C., thereby allowing the powder to reach the same temperature. A liquid mixture of 13.85 g (0.157 mole) 1,4-diaminobutane and 164.8 g (1.21 mole) of MXD was prepared by melting and mixing the diamines at room temperature and heated in a dosing vessel to 65° C. Then, the liquid mixture was added drop-wise to the acid powder at a dosing rate of 0.5 g ml/minute under constant rotation. After completion of the dosing, the reaction mixture was stirred by rotation while keeping the flask in the oil bath at a temperature of 65° C. for another 120 minutes. Then the flask was cooled to room temperature and the salt was discharged from the flask. The salt so obtained was a free flowing powder with a melting point of 284° C.

### S2. Preparation: MXDT/4T Salt

Example S1 was repeated except that 227.02 g (1.344 mole) of solid terephthalic acid powder was charged into the baffled flask and a mixture of 148.9 g (1.093 mole) MXD and 26.1 g (0.296 mole) 1,4-diaminobutane was added at a rate of 0.5 ml/min. The salt so obtained was a free flowing powder with a melting point of 283° C.

### S3. Salt Preparation: MXDT/6T Salt

Example S1 was repeated except that a mixture of 146.1 g (1.073 mole) MXD and 35.16 g (0.303 mole) hexamethylenediamine was added at a rate of 0.5 g/min to 221.3 g (1.341 mole) of solid terephthalic acid. The salt so obtained was a free flowing powder with a melting point Tm1 of 286° C.

### S4 Salt Preparation MXDT/4T Salt

The salt preparation was carried out in a double walled 1 liter electrically heated metal reactor equipped with a helically shaped stirring unit, an inert gas inlet and an exit for the inert gas and the condensate gas to leave the reactor, and thermometers to measure the temperature of the reactor wall and the reactor content. The reactor was charged with 113.51 g of solid terephthalic acid powder. The terephthalic acid powder was stirred and a nitrogen gas purge of 5 gram per hour was applied during 3 hours to inertize the reactor content. Then the nitrogen stream was stopped and the reactor content was heated to 180° C. in 1 hour by heating the reactor wall and lid. A liquid mixture of 13.05 g of 1,4-diaminobutane and 74.5 g of MXD was prepared by mixing the diamines at room temperature and dosing at room temperature of 22° C., into the dosing vessel. The liquid mixture was added drop-wise to the acid powder in 4 hours at a dosing rate of 0.25 ml/minute under constant rotation. After completion of the dosing, the reaction mixture was stirred by rotation while keeping the reactor content at a temperature of 180° C. for another 120 minutes. Then the reactor was cooled to room temperature and the salt was discharged from the flask. The salt so obtained was a powder with a melting point of 285° C.

### S5 Salt Preparation: MXDT/6T Salt

Example S1 was repeated except that a mixture of 111.05 g (0.815 mole) MXD and 71.17 g (0.613 mole) hexamethylenediamine was added at a rate of 0.5 g/min to 225.78 g (1.359 mole) of solid terephthalic acid. The salt so obtained was a free flowing powder with a melting point Tm1 of 271° C.

### Polymerization Experiments

### EXAMPLE

### S6: Salt Preparation: MXDT/6T/4T Salt

Example S1 was repeated except that a mixture of 129.84 g (0.953 mole) MXD, 14.20 g (0.122 mole) hexamethylenediamine and 10.88 g (0.123 mole) 1,4-diaminobutane was added at a rate of 0.5 g/min to 221.3 g (1.341 mole) of solid terephthalic acid. The salt so obtained was a free flowing powder with a melting point Tm1 of 286° C.

### Example E1

### Copolyamide PA-MXDT/4T in a Stirred Reactor with Salt from Example S1

The polymerization was carried out in a double walled 1 liter electrically heated metal reactor equipped with a helically shaped stirring unit, an inert gas inlet and an exit for the inert gas and the condensate gas to leave the reactor, and thermometers to measure the temperature of the reactor wall and the reactor content. The reactor was charged with salt powder. The salt powder was stirred and a nitrogen gas purge of 5 gram per hour was applied to inertize the reactor content. Then the reactor content was heated by heating the reactor wall applying a programmed temperature profile and monitoring the temperature of the reactor content in the powder bed, meanwhile continuing the nitrogen gas purge and stirring of the reactor content.

300 g of the salt of Example S1 was used. The nitrogen gas purge was set and kept at 5 gram per hour gas volume at room temperature. The reactor content was inertized during 3 hours, before starting the heating profile. The reactor content was heated from 25 to 220° C. in 2 hrs, kept at 220° C. for 3 hours, heated to 235° C. in 5 hours, heated to 265° C. in 1.5 hours, and then heated to 275° C. Then the nitrogen purge was stopped. Then 15 g of MXD was dosed to the closed reactor over 60 minutes, after which the nitrogen purge was opened again at 5 gram per hour and the temperature kept for two more hours at 275° C. Then the reactor content was cooled to <100° C. in 2 hrs resulted in a free flowing polymer. Yield 260 g. Results are shown in Table 1.

### Example E2

### Copolyamide PA-MXDT/4T in Stirred Reactor with Salt from Example S2

Example E1 was repeated except that for the salt 300 g of the salt powder of Example S2 was used. The analytical results are shown in table 1.

### Example E3

### Copolyamide PA-MXDT/6T in Stirred Reactor with Salt from Example S3

Example E1 was repeated except that for the salt 300 g of the salt powder of Example S3 was used. The heating profile was different from example E1. The reactor content was heated from 25 to 220° C. in 2 hrs, kept at 220° C. for 3 hours, heated to 235° C. in 5 hours, heated to 265° C. in 2 hours, and then kept for five hours at 265° C. No post dosing of diamines was performed during the polymerization. Then the reactor content was cooled to <100° C. in 2 hrs resulted in a free flowing polymer. The analytical results are shown in table 1.

### Example E4

### Copolyamide PA-MXDT/4T in Stirred Reactor with Salt from Example S4

Example E1 was repeated except that for the salt 300 g of the salt powder of Example S4 was used. The analytical results are shown in table 1.

### Example E5

### Copolyamide PA-MXDT/6T in Stirred Reactor with Salt from Example S5

Example E3 was repeated except that for the salt 300 g of the salt powder of Example S5 was used. The heating profile was different from example E3. The reactor content was heated from 25 to 220° C. in 2 hrs, heated to 223° C. kept at 223° C. for 3 hours, heated to 238° C. in 10 hours, heated to 257° C. in 2.5 hours, and then kept for one hours at 257° C. No post dosing of diamines was performed during the polymerization. Then the reactor content was cooled to <100° C. in 2 hrs resulted in a free flowing polymer. The analytical results are shown in table 1.

### Example E6

### Copolyamide PA-MXDT/6T/4T in Stirred Reactor with Salt S6

Example E1 was repeated except that for the salt 300 g of the salt powder of Example S6 was used and that instead of 15 g 1,4-diaminobutane, 15 g of a liquid mixture of 7.5 g hexamethylenediamine and 7.5 g 1,4-diaminobutane was added. The analytical results are shown in table 1.

### Comparative Experiment A

### Production of PA-MXDT/4T from a MXD/1,4-Diaminobutane Composition

A liquid mixture of 1.47 g of (0.017 mole) 1,4-diaminobutane and 16.48 g (0.121 mole) of MXD was prepared by mixing the diamines at room temperature and filling them into a cylindrical 100 ml glass vessel, equipped with a distillation tube to remove volatile components. 22.34 g (0.134 mole) of solid terephthalic acid powder was added while mixing with a spatula. The tube was immersed into an electrical heating block. The reactor was closed, inertized by evacuation and refilling with nitrogen and repeating this three times and heating the thick slurry in 90 minutes from room temperature to 275° C. At 195° C. the slurry became a solid block of sintered powder. The experiment was stopped by cooling down. This demonstrates that batch preparation of this material in a technological way is not possible for this monomer combination as described in U.S. Pat. No. 4,018,746.

### Comparative Experiment B

### Solution Polymerization of MXDT/4T from a MXD/1,4-Diaminobutane Composition

A pressure vessel of 2 liter capacity equipped with a stirrer, a thermometer, a pressure gauge, a nitrogen gas inlet, a gas outlet to release evaporation water, and a polymer outlet, was charged with 13.85 g (0.157 mole) 1,4-diaminobutane, 164.8 g (1.21 mole) MXD and 300 g water. To the resulting solution 223.35 g (1.344 mole) of solid terephthalic acid powder was added to form an MXDT/4T salt slurry. The reactor content was inertized with nitrogen gas. The material was heated to 200° C. resulting in a clear solution. Then 260 g water was removed by distillation in 30 minutes, while keeping at 5 bar overpressure, allowing the temperature to increase. At the end of the distillation, the temperature was increased to 250° C. in 10 minutes and kept at that temperature for 15 minutes. Then, the material was removed from the reactor by releasing into a metal vessel at room temperature, which was purged with a nitrogen stream to keep it inert and equipped with an outlet to allow escape of gasses during the release. The material obtained was amorphous glassy material at room temperature. Heating above the glass transition temperature, the material became a sticky material which prohibited solid state post-condensation.

TABLE 1
Analytical values of polyamides obtained by Examples E1-E6 and
Comparative Examples A and B

| | Tm1 | ΔHm1 | Tm2 | ΔHm2 | |
|---|---|---|---|---|---|
| | [° C.] | [J/g] | [° C.] | [J/g] | |
| | 1st heating | 1st heating | 2nd heating | 2nd heating to | VN |
| | to 350° C. | to 350° C. | to 350° C. | 350° C. | [ml/g] |
| E1 | 306 | 65 | 325 | 10 | 56 |
| E2 | 294 | 61 | 330 | 16 | 54 |
| E3 | 325 | 72 | — | 0 | 110 |
| E4 | 318 | 60 | 334 | 15 | 61 |
| E5 | 295 | 68 | 261 | 2 | 70 |
| E6 | 310 | 65 | 325 | 12 | 70 |
| A | | | | | * |
| B | | | | | * |

* No VN could be determined because the PTA that is liberated upon dissolving the salt in H2SO4 did not dissolve in H2SO4.

The numbers behind Tm refer to whether they are determined in the first heating (1) or in the second heating (2).

### Comparative Example C

### Salt Preparation and Polymerization of MXDT/4T/MXD6 Salt from a MXDT/4T/MXD6 Composition

### Salt Preparation

175.94 g (1.059 mole) of solid terephthalic acid powder and 27.31 g (0.187 mole) of solid adipic acid powder was charged into a 2 litre baffled flask. The flask was attached to a rotary evaporator equipped with a heated diamine dosing vessel, inertized by purging with 5 gram per hour nitrogen gas for 1 hour. The content in the flask was mixed by rotation of the flask at 60 rpm and kept under nitrogen atmosphere (5 gram per hour). The rotating flask was partially submerged in an oil bath maintained at 90° C., thereby allowing the powder to reach the same temperature. A liquid mixture of 11.42 g (0.130 mole) 1,4-diaminobutane and 136.56 g (1.003 mole) of MXD was prepared by melting and mixing the diamines at room temperature and heated in a dosing vessel to 65° C. Then, the liquid mixture was added drop-wise to the acid powder at a dosing rate of 0.3 g ml/minute under constant rotation. After completion of the dosing, the reaction mixture was stirred by rotation while keeping the flask in the oil bath at a temperature of 90° C. for another 120 minutes. Then the flask was cooled to room temperature and the salt was discharged from the flask. The salt so obtained was a free flowing powder.

### Polymerization

The polymerization was carried out in a double walled 1 liter electrically heated metal reactor equipped with a helically shaped stirring unit, an inert gas inlet and an exit for the inert gas and the condensate gas to leave the reactor, and thermometers to measure the temperature of the reactor wall and the reactor content. The reactor was charged with salt powder. The salt powder was stirred and a nitrogen gas purge of 5 gram per hour was applied to inertize the reactor content. Then the reactor content was heated by heating the reactor wall applying a programmed temperature profile and monitoring the temperature of the reactor content in the powder bed, meanwhile continuing the nitrogen gas purge and stirring of the reactor content. 300 g of the salt was used. The nitrogen gas purge was set and kept at 5 gram per hour gas volume at room temperature. The reactor content was inertized during 3 hours, before starting the heating profile. The reactor content was heated from 25 to 210° C. in 114 minutes, At 210° C. the torque increased and the stirring unit blocked, the reactor mass became a solid block of sintered powder. The experiment was stopped by cooling down. This demonstrates that batch preparation of this material in a technological way is not possible for this monomer combination according to the invention.

### Comparative Example D

### Preparation and Polymerization of MXDT/4T/MXDI Salt from a MXDT/4T/MXDI Composition

### Salt Preparation

166.12 g (1.000 mole) of solid terephthalic acid powder and 29.31 g (0.176 mole) of solid isophthalic acid powder was charged into a 2 litre baffled flask. The flask was attached to a rotary evaporator equipped with a heated diamine dosing vessel, inertized by purging with 5 gram per hour nitrogen gas for 1 hour. The content in the flask was mixed by rotation of the flask at 60 rpm and kept under nitrogen atmosphere (5 gram per hour). The rotating flask was partially submerged in an oil bath maintained at 65° C., thereby allowing the powder to reach the same temperature. A liquid mixture of 10.81 g (0.123 mole) 1,4-diaminobutane and 145.00 g (1.065 mole) of MXD was prepared by melting and mixing the diamines at room temperature and heated in a dosing vessel to 65° C. Then, the liquid mixture was added drop-wise to the acid powder at a dosing rate of 0.5 g ml/minute under constant rotation. After completion of the dosing, the reaction mixture was stirred by rotation while keeping the flask in the oil bath at a temperature of 65° C. for another 120 minutes. Then the flask was cooled to room temperature and the salt was discharged from the flask. The salt so obtained was a free flowing powder.

### Polymerization

The polymerization was carried out in a double walled 1 liter electrically heated metal reactor equipped with a helically shaped stirring unit, an inert gas inlet and an exit for the inert gas and the condensate gas to leave the reactor, and thermometers to measure the temperature of the reactor wall and the reactor content. The reactor was charged with salt powder. The salt powder was stirred and a nitrogen gas purge of 5 gram per hour was applied to inertize the reactor content. Then the reactor content was heated by heating the reactor wall applying a programmed temperature profile and monitoring the temperature of the reactor content in the powder bed, meanwhile continuing the nitrogen gas purge and stirring of the reactor content. 300 g of the salt was used. The nitrogen gas purge was set and kept at 5 gram per hour gas volume at room temperature. The reactor content was inertized during 3 hours, before starting the heating profile. The reactor content was heated from 25 to 220° C. in 120 minutes, After the reactor content was kept at 220° C. After 20 minutes, the torque increased and the stirring unit blocked, because the reactor mass became a solid block of sintered powder. The experiment was stopped by cooling down. This demonstrates that batch preparation of this material in a technological way is not possible for this monomer combination according to the invention.

### Comparative Example E

### Process for Salt Preparation and Polymerization of PA-MXD6

### Salt Preparation

196.4 g (1.344 mole) of solid adipic acid powder was charged into a 2 litre baffled flask, charged with 1.3 liter ethanol. The flask was attached to a rotary evaporator equipped with a heated diamine dosing vessel, inertized by purging with 5 gram per hour nitrogen gas for 1 hour. The content in the flask was mixed by rotation of the flask at 60 rpm and kept under nitrogen atmosphere (5 gram per hour). The rotating flask was partially submerged in an oil bath maintained at 65° C., thereby allowing the powder to reach the same temperature. The liquid 186.6 g (1.37 mole) MXD was added drop-wise to the acid powder at a dosing rate of 0.5 g ml/minute under constant rotation. After completion of the dosing, the reaction mixture was stirred by rotation while keeping the flask in the oil bath at a temperature of 65° C. for another 120 minutes. Then the flask was cooled to room temperature and the salt slurry was discharged from the flask. The MXD6 salt was isolated by filtration and dried in a vacuum of 50 mbar under inert atmosphere at 50° C. during 16 hours.

### Polymerization

The polymerization was carried out in a double walled 1 liter electrically heated metal reactor equipped with a helically shaped stirring unit, an inert gas inlet and an exit for the inert gas and the condensate gas to leave the reactor, and thermometers to measure the temperature of the reactor wall and the reactor content. The reactor was charged with salt powder. The salt powder was stirred and a nitrogen gas purge of 5 gram per hour was applied to inertize the reactor content. Then the reactor content was heated by heating the reactor wall applying a programmed temperature profile and monitoring the temperature of the reactor content in the powder bed, meanwhile continuing the nitrogen gas purge and stirring of the reactor content.

300 g of the salt was used. The nitrogen gas purge was set and kept at 5 gram per hour gas volume at room temperature. The reactor content was inertized during 3 hours, before starting the heating profile. The reactor content was heated from 25 to 195° C. in 2 hrs, At 195° C. the mass became a solid block of sintered powder. The experiment was stopped by cooling down. This demonstrates that batch preparation of this material in a technological way is not possible for this monomer combination according to the invention.

It can be seen from Comparative Example E, that the process according to the present invention is not a suitable process for obtaining the corresponding copolymer.

### Comparative Example F

### Process for Salt Preparation and Polymerization of PA-MXDI/41

A liquid mixture of 1.47 g of (0.017 mole) 1,4-diaminobutane and 16.48 g (0.121 mole) of MXD was prepared by mixing the diamines at room temperature and filling them into a cylindrical 100 ml glass vessel, equipped with a distillation tube to remove volatile components. 22.34 g (0.134 mole) of solid isophthalic acid powder was added while mixing with a spatula. The tube was immersed into an electrical heating block. The reactor was closed, inertized by evacuation and refilling with nitrogen and repeating this three times and heating the thick slurry in 90 minutes from room temperature to 275° C. At 195° C. the slurry became a solid block of sintered powder. The experiment was stopped by cooling down. This demonstrates that batch preparation of this material in a technological way is not possible for this monomer combination as described in U.S. Pat. No. 4,018,746.

It can be seen from Comparative Example F, that the process according to the present invention is not a suitable process for obtaining the corresponding copolymer.

1. Process for the production of a PA-MXDT/ZT polyamide copolymer comprising the following steps:
i. providing a solid MXDT/ZT salt, wherein MXD is meta-xylylenediamine, T is terephthalic acid, Z is a linear aliphatic diamine having from 2 to 12 carbon atoms and wherein amount of Z is from 5 to 40 mole % with respect to the total amount of MXD and Z units in the copolymer and wherein the MXDT/ZT salt is provided by dosing of liquid diamines MXD and Z to a powder of terephthalic acid;
ii. heating the solid MXDT/ZT salt to a first condensation temperature (Tc1) thereby condensing the salt in solid state to produce a solid polyamide copolymer, wherein Tc1 is below the melting temperature (Tm-salt) of said salt.

2. Process according to claim 1, comprising a step of
iii. condensing the solid polyamide copolymer from step (ii) further at a second condensation temperature (Tc2) below the melting temperature of the solid polyamide copolymer (Tm1) produced in step (ii) to a produce a polyamide copolymer of a higher degree of polymerization.

3. Process according to claim 1, wherein Tc1 is at least 210° C.

4. Process according to claim 1, wherein the MXDT/ZT salt is prepared by dosing of liquid diamines MXD and Z to a agitating powder of terephthalic acid;

5. Process according to claim 4, wherein the liquid diamine is dosed at a dosing rate of at most 4 mole % diamine per minute, relative to the molar amount dicarboxylic acid.

6. Process according to claim 1, wherein the MXDT/ZT salt is prepared from terephthalic acid and diamines MXD and Z in an aqueous solution.

7. Process according to claim 1, wherein the diamine/dicarboxylic acid molar ratio in the solid MXDT/ZT salt is in the range of 1.10-0.90, preferably 1.05-0.95, 1.02-0.98.

8. PA-MXDT/ZT polyamide copolymer, wherein MXD is meta-xylylenediamine, T is terephthalic acid, Z is a linear aliphatic diamine having from 2 to 12 carbon atoms, Z is from 5 to 40 mole % with respect to the total of MXD and Z units in the copolymer.

9. Copolymer according to claim 8, wherein Z is selected from the group consisting of 1,4-diaminobutane, 1,5-diaminopentane, and hexamethylenediamine.

10. PA-MXDT/Z′T/Z²T polyamide copolymer, wherein MXD is meta-xylylenediamine, T is terephthalic acid, Z¹ and Z² are diamines selected from the group consisting of 1,4-diaminobutane, 1,5-diaminopentane, and hexamethylenediamine, and are present in an amount ranging from 5 to 40 mole % with respect to the total of MXD and Z units in the copolymer.

11. PA-MXDT/Z¹T/Z²T/Z³T polyamide copolymer, wherein MXD is meta-xylylenediamine, T is terephthalic acid, Z¹, Z² and Z³ are diamines selected from the group consisting of 1,4-diaminobutane, 1,5-diaminopentane, and hexamethylenediamine, and are present in an amount ranging from 5 to 40 mole % with respect to the total of MXD and Z units in the copolymer.

12. Copolymer according to claim 8, wherein the copolymer has a melting enthalpy ΔHm1 measured by DSC with a scan rate of 20° C./min in the first DSC heating cycle with a melting enthalpy of at least 25 J/g and determined by the method according to ISO 11357-1/3.

13. Copolymer according to claim 8 wherein the copolymer has a viscosity number (VN) measured in 96% H2SO4 (0.005 g/ml) at 25° C. determined by the method ISO 307, fourth edition of at least 50 ml/g.

14. Copolymer according to claim 8, wherein the copolymer has a melting enthalpy ΔHm2 of at most 25 J/g, measured by DSC with a scan rate of 20° C./min in the second heating cycle after heating to 350° C. and direct cooling and determined by the method according to ISO 11357-1/3.

15. Moulding composition comprising the copolymer of claim 8.
